(19) United States
(12) Patent Application Publication
(10) Pub. No.: US 2020/0055268 A1
(43) Pub. Date: Feb. 20, 2020

(54) TIRE CURING SYSTEM

(71) Applicant: The Goodyear Tire & Rubber Company, Akron, OH (US)

(72) Inventor: Ceyhan CELIK, Stow, OH (US)

(21) Appl. No.: 16/105,242

(22) Filed: Aug. 20, 2018

(51) Int. Cl. B29D 30/02

(52) U.S. Cl. CPC B29D 30/02

(57) ABSTRACT

A system pretensions part of a wheel and tire assembly. The system includes a plurality of support elements for supporting part of a load of a vehicle and an annular shear band extending circumferentially around the support elements. The band has a radially inner circumferential membrane, a radially outer circumferential membrane, and a shear layer interconnecting the inner membrane and the outer membrane. The shear layer has a structure pretensioned prior to installation of the assembly on a vehicle.

### FIELD OF THE INVENTION

The present invention relates to laminated products or products made of several layers or bands of planar or non-planar form, which are joined together. The present invention relates, more particularly, to resilient (flexible) wheels and tires for motor vehicles.

### BACKGROUND OF THE PRESENT INVENTION

Conventional non-pneumatic tires, when associated with any rigid mechanical element intended to provide a connection between the non-pneumatic tire and a wheel, have in some cases replaced the pneumatic tire, rim and disc utilized with many vehicles.

One conventional non-pneumatic tire may be structurally supported without pressurized gas. The non-pneumatic tire may include a reinforced annular band supporting the load on the tire and a plurality of support elements or spokes having relatively low stiffness in compression and operate in tension to transmit forces between the annular band and a wheel of the vehicle.

Such an annular band, or shear band, may include two membranes formed from essentially inextensible cords coated with natural or synthetic rubber. The membranes may be separated by a shear layer itself made of rubber. The operating principle of such a shear band may be that a shear modulus of the shear layer may be substantially lower than a tensile modulus of the two membranes. The shear layer may be sufficient, however, to correctly transmit forces from one membrane to the other membrane thus allowing the shear band to work in a shear mode.

The conventional shear band thereby operate in severe or harsh conditions with essentially no risk of puncture and without any pressure maintenance requirement. Moreover, compared with the non-pneumatic tires of the prior art, a ground contact pressure which is more uniformly distributed, hence better working of the tire, an improved road holding and improved wear resistance are obtained here.

However, such a rubber shear band is not without drawbacks.

Firstly, at the customary operating temperatures, for example between −30° C. and +40° C., it is relatively hysteretic, that is to say that some of the energy supplied for rolling is dissipated (lost) in the form of heat. Next, for significantly lower operating temperatures, such as those that can be found, for example in geographical areas of polar type, typically below −50° C. or even less, it is well known that rubber rapidly becomes brittle, frangible and therefore unusable. Under such extreme conditions, it is moreover understood that temperature fluctuations that are more or less sizable and rapid, combined, for example, with relatively high mechanical stresses, could also lead to adhesion problems between the two membranes and the shear layer, with a risk of localized buckling of the shear band level with the membranes and endurance that is in the end degraded.

### SUMMARY OF THE INVENTION

A system in accordance with the present invention pretensions part of a wheel and tire assembly. The system includes a plurality of support elements for supporting part of a load of a vehicle and an annular shear band extending circumferentially around the support elements. The band has a radially inner circumferential membrane, a radially outer circumferential membrane, and a shear layer interconnecting the inner membrane and the outer membrane. The shear layer has a structure pretensioned prior to installation of the assembly on a vehicle.

According to another aspect of the system, the shear layer is pretensioned during a curing step.

According to still another aspect of the system, the shear layer is pretensioned by an incompressible fluid.

According to yet another aspect of the system, the shear layer is pretensioned by an incompressible fluid during a curing step.

According to still another aspect of the system, the shear layer is fluid sealed.

According to yet another aspect of the system, the shear layer is pretensioned by water.

According to still another aspect of the system, the shear layer is pretensioned by pressurized water.

According to yet another aspect of the system, the shear layer is pretensioned by oil.

According to still another aspect of the system, the shear layer is pretensioned by pressurized oil.

According to yet another aspect of the system, the shear layer is pretensioned by heated and pressurized oil.

A method in accordance with the present invention pretensions part of a wheel and tire assembly. The method includes the steps of: supporting part of a load of a vehicle by a structure; extending an annular shear band circumferentially around the structure; interconnecting a radially inner circumferential membrane and a radially outer circumferential membrane by the annular shear layer; and pretensioning the annular shear layer prior to installation of the assembly on a vehicle.

According to another aspect of the method, the pretensioning step includes a curing step.

According to still another aspect of the method, the pretensioning step includes using an incompressible fluid.

According to yet another aspect of the method, the pretensioning step includes fluid sealing the annular shear layer.

According to still another aspect of the method, the pretensioning step includes water.

According to yet another aspect of the method, the pretensioning step includes pressurizing water.

According to still another aspect of the method, the pretensioning step includes oil.

According to yet another aspect of the method, the pretensioning step includes pressurizing oil.

According to still another aspect of the method, the pretensioning step includes heating and pressurizing oil.

### Definitions

The following definitions are controlling for this patent application.

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Inward” directionally means toward the tire cavity.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-pneumatic” means a lack of pressurized inflation gases, such as air, in order to assume a functional or usable form.

“Outward” directionally means in a direction away from the tire cavity.

“Radial” and “radially” means directions radially toward or away from the axis of rotation of the tire.

“Tread element” or “traction element” means a rib or a block element defined by having a shape adjacent grooves.

### BRIEF DESCRIPTION OF THE DRAWINGS

A detailed description and examples of the present invention are presented in connection with the figures relating to these examples, which schematically show (without a specific scale):

FIG. 1 schematically shows a side view of a wheel and tire assembly in accordance with the present invention;

FIG. 2 schematically shows part of one example constituent component of the assembly of FIG. 1;

FIG. 3 schematically shows an alternative structure of the component of FIG. 2;

FIG. 4 schematically shows another alternative structure of the component of FIG. 2;

FIG. 5 schematically shows still another alternative structure of the component of FIG. 2; and

FIG. 6 schematically shows yet another alternative structure of the component of FIG. 2.

### DETAILED DESCRIPTION OF EXAMPLES OF THE PRESENT INVENTION

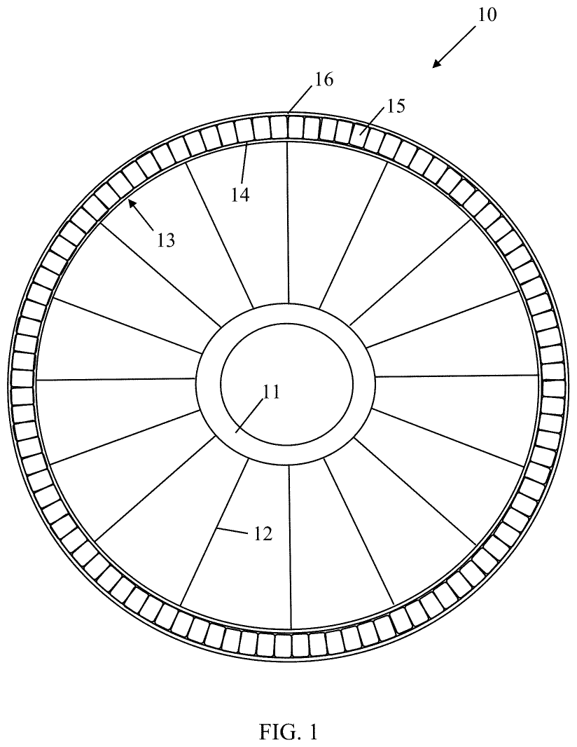

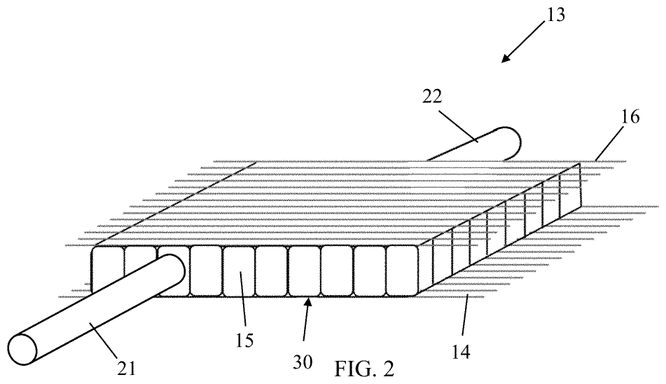

By way of example, FIG. 1 schematically represents a side view (e.g., in a plane perpendicular to an axis of rotation) of a pneumatic or a non-pneumatic resilient wheel and tire assembly 10 structurally supported (e.g., by a load-bearing structure) by a circumferential shear band 13 of which comprises by a lattice structure (FIG. 2).

The example assembly 10 may comprise a hub 11, an annular band referred to as a shear band 13 may include at least one inner circumferential membrane 14 and one outer circumferential membrane 16 that are oriented in the circumferential direction, and a plurality of support elements or spokes 12 that connect the hub 11 to the inner circumferential membrane 14. The two membranes 14, 16 may be interconnected by a layer 15 of partially closed cells (FIG. 2). The layer 15 may define a three-dimensional closed chamber which may be filled and pressurized with an incompressible fluid (e.g., water, oil, etc.) during tire building and curing. Thereafter, the fluid may be drained thereby pretensioning the connecting structures of the closed chamber. The presence of the fluid may also accelerate heating and cooling of the shear band 13 during and after curing.

The membranes 14, 16 may be formed with liquid sealing film and the sides of the layer 15 may be temporarily and/or permanently sealed such that the liquid is contained appropriately during curing of the tire. A fill tube 21 may be attached to a side of the layer 15 for introducing the fluid into the closed chamber. A vent tube 22 may be attached to a side of the layer 15 at another location to vent air until the closed chamber is filled with the liquid. on all fabric surfaces and placing tubing on sides to a pressurizing fluid. The sides of the layer 15 may be reinforced (e.g., fabric, rubber, etc.) to improve structural integrity against an inner pressurizing force of the liquid during curing. Curing may pressurize the fluid or the fluid may also be additionally pressurized before curing.

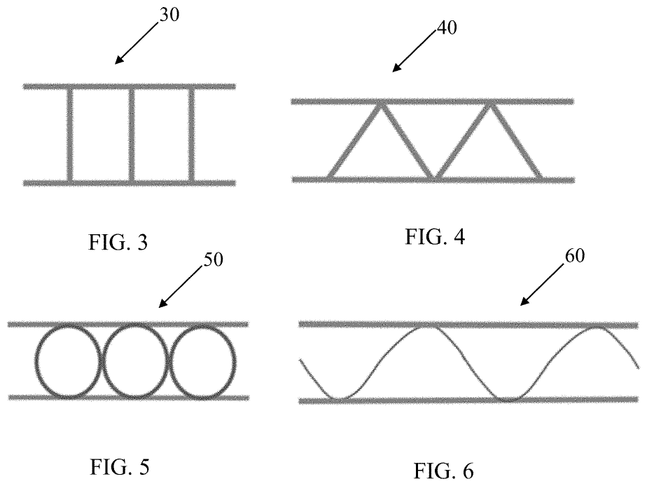

The shear band 13 may further include a resorcinol-formaldehyde latex or a similar adhesive coating for bonding of the shear layer to other structures of the tire. The layer 15 may be constructed from continuous cells separated by fabric walls with openings fluid transfer between the continuous cells. FIGS. 2 & 3 show one example orthogonal, or I-beam, cell structure 30. FIG. 4 shows another example triangular cell structure 40. FIG. 5 shows still another example cylindrical cell structure 50. FIG. 6 shows yet another example wavy or sinusoidal cell structure 60.

The shear band 13 may be held together and secured to the spokes 12 by heat sealing, by adhesive binding, and/or by other suitable means. The sealing layer of the membranes 14, 16 may be made from suitable laminated sheet plastic, such as polyethylene terephthalate. Other similar flexible coverings, such as vinyl and/or leather, may be used to dispose the layer 15 on the two membranes 14, 16.

One example adhesive may be RFL (resorcinol-formaldehyde-latex). An RFL adhesive may include a polymer latex which may be based on natural rubber, styrene-butadiene rubber, acrylonitrile-butadiene rubber (NBR), hydrogenated acrylonitrile-butadiene rubber (HNBR) and vinyl pyridine. An optional ingredient to the RFL may be an isocyanate compound. Additional examples of suitable adhesives may be polyvinyl acetate, polyacrylic, polyvinyl chloride and polyurethane. Cement solutions (organic) of polymers may also be used as an adhesive. Representative polymers may include natural rubber, polychloroprene, acrylonitrile-butadiene copolymers, polyisoprene, zinc salts of unsaturated carboxylic acid ester grafted hydrogenated nitrile butadiene elastomers, styrene-butadiene rubbers, polybutadiene, EPDM, hydrogenated acrylonitrile-butadiene copolymers, polyurethane and ethylene-acrylic elastomers.

The adhesive may be first applied to the membranes 14, 16 and the layer 15 may be thereafter applied. The adhesive may be applied to the membranes 14, 16 either before or after being adhered to the layer 15.

There may be many methods for applying adhesive. The adhesive may be applied with a knife, reverse roll or roll-over-platform coaters. Engraved rolls, spray applicators, and/or rotary screen printers may also be used. Other examples may include silk-screen, dipping, brushing, and/or spraying. The thickness of the adhesive may vary, such as from about 0.05 mm to about 1.0 mm, or from 0.05 mm to 0.40 mm.

The layer 15 may be applied to the plies or membranes 14, 16 and thereafter applied to the membranes 14, 16. The layer 15 may be applied to an adhesive-coated surface either mechanically, electrostatically, and/or by means of a combination of both techniques.

While present exemplary examples of the present invention and methods of practicing the same have been illustrated and described, it will be recognized that this invention may be otherwise variously embodied and practiced within the scope of the following claims. Other similar flexible coverings, such as vinyl and/or leather, may be used with the on the two membranes 14, 16.

This layer 15, or deformable cellular structure, may thus be used as a non-planar elastic beam, may exhibit a high resistance to flexural/compressive stresses and a high endurance to alternated stresses or cyclic-loading. The layer 15 may generate a deformation comparable to shear between its two membranes 14, 16 under the action of various tensile, flexural and/or compressive stresses incurred by the structure during rotation of the assembly 10 under load. The annular shear band may thus have a high deformation potential in a purely elastic domain. The structure 15 may be durable and exhibit purely elastic behavior up to rupture. This property may also apply to the membranes 14, 16 when the membranes are themselves made from a composite material (e.g., fibers/resin). Compared with a metal shear band, the shear band 13 may be more durable, substantially lighter, and/or corrosion resistant.

The two membranes 14, 16 may be constructed of a material other than that of the layer 15, such as metal, polymer, fabric, wrapped cord, etc. The membranes 14,16 themselves may thereby be composites comprising fibers embedded in a resin or rubber matrix. Thus, the whole of the annular shear band 13, constituted by the two membranes 14, 16 and the layer 15, may be constructed of a composite material. Further, fibers/wires of the membranes 14, 16 may be continuous, unidirectional, and/or oriented parallel to the circumferential direction so that the membranes have a maximum tensile strength in the circumferential direction.

The assembly 10 of the present invention may be used in all types of land based or non-land based vehicles and, in particular, vehicles intended to face severe or harsh rolling conditions or extreme temperatures, such as those which could be encountered, for example, by lunar rover vehicles, road transport vehicles, off-road vehicles and/or any other type of transport or handling vehicles.

Variations in the present invention are possible in light of the description of examples of it provided herein. While certain representative examples and details have been shown for the purpose of illustrating the present invention, it will be apparent to those skilled in this art that various changes and modifications may be made therein without departing from the scope of the present invention. It is, therefore, to be understood that changes may be made in the examples described which will be within the full intended scope of the present invention as defined by the following appended claims.

What is claimed:

1. A system for pretensioning part of a wheel and tire assembly comprising:
a plurality of support elements for supporting part of a load of a vehicle; and
an annular shear band extending circumferentially around the support elements, the band having a radially inner circumferential membrane, a radially outer circumferential membrane, and a shear layer interconnecting the inner membrane and the outer membrane, the shear layer having a structure pretensioned prior to installation of the assembly on a vehicle.

2. The system as set forth in claim 1 wherein the shear layer is pretensioned during a curing step.

3. The system as set forth in claim 1 wherein the shear layer is pretensioned by an incompressible fluid.

4. The system as set forth in claim 1 wherein the shear layer is pretensioned by an incompressible fluid during a curing step.

5. The system as set forth in claim 1 wherein the shear layer is fluid sealed.

6. The system as set forth in claim 1 wherein the shear layer is pretensioned by water.

7. The system as set forth in claim 1 wherein the shear layer is pretensioned by pressurized water.

8. The system as set forth in claim 1 wherein the shear layer is pretensioned by oil.

9. The system as set forth in claim 1 wherein the shear layer is pretensioned by pressurized oil.

10. The system as set forth in claim 1 wherein the shear layer is pretensioned by heated and pressurized oil.

11. A method for pretensioning part of a wheel and tire assembly comprising:
supporting part of a load of a vehicle by a structure;
extending an annular shear band circumferentially around the structure;
interconnecting a radially inner circumferential membrane and a radially outer circumferential membrane by the annular shear layer; and
pretensioning the annular shear layer prior to installation of the assembly on a vehicle.

12. The method as set forth in claim 11 wherein said pretensioning step includes a curing step.

13. The method as set forth in claim 11 wherein said pretensioning step includes using an incompressible fluid.

14. The method as set forth in claim 11 wherein said pretensioning step includes fluid sealing the annular shear layer.

15. The method as set forth in claim 11 wherein said pretensioning step includes water.

16. The method as set forth in claim 11 wherein said pretensioning step includes pressurizing water.

17. The method as set forth in claim 11 wherein said pretensioning step includes oil.

18. The method as set forth in claim 11 wherein said pretensioning step includes pressurizing oil.

19. The method as set forth in claim 11 wherein said pretensioning step includes heating and pressurizing oil.
